(19) United States
(12) Patent Application Publication
(10) Pub. No.: US 2023/0391638 A1
(43) Pub. Date: Dec. 7, 2023

(54) FILTERING UNIT

(71) Applicant: SOCIETE DES PRODUITS NESTLE S.A., Vevey (CH)

(72) Inventor: ALEXANDRE PUGLIESE, Paudex (CH)

(21) Appl. No.: 18/247,656

(22) PCT Filed: Sep. 16, 2021
(86) PCT No.: PCT/EP2021/075406

§ 371 Date: Apr. 3, 2023

(30) Foreign Application Priority Data
Oct. 6, 2020 (EP) 20200390.1

(51) Int. Cl. C02F 1/28; C02F 1/42; A23L 2/72

(52) U.S. Cl. CPC C02F 1/283; C02F 1/42; A23L 2/72; C02F 2303/04; C02F 2101/30

(57) ABSTRACT

A filtering unit (70), comprising: a first cavity (71) with a first filtering technology for filtering a liquid, and with a first outlet (76) for dispensing the liquid filtered by the first filtering technology; and a second cavity (77) with a second filtering technology, which is different from the first filtering technology, for filtering a liquid, and with a second outlet (82) for dispensing the liquid filtered by the second filtering technology. The first cavity (71) and the second cavity (77) are integrated in a same unit.

### 1. FIELD OF THE INVENTION

The present invention relates to a filtering unit, a system comprising such a filtering unit, a beverage system comprising such a filtering unit or system, and a method of filtration.

### 2. TECHNICAL BACKGROUND

A filtering unit is used to filter a liquid, i.e. filter or separate out specific substances from the liquid so that the liquid is free from these substances or at least includes a reduced amount of these substances. This may be desired, because the substances, for example, produce a disease, lower the quality (taste and/or odor) of the liquid, and/or cause technical problems.

On the one hand, the filtering unit thus filters a specific substance from the liquid so that, in one implementation, a specific problem, such as a technical problem, is prevented or at least reduced. On the other hand, it may be desired that, in another implementation, this specific substance is present in the liquid and, thus, not filtered, for example in order to have healthy benefits when consuming the liquid or a beverage made from the liquid that includes this specific substance.

However, in order to facilitate such different implementations for providing differently filtered liquids, a complex overall liquid and filtration system is required.

Therefore, it is an object of the present invention to provide a filtering unit and a method of filtration, which overcome the afore-mentioned drawbacks. That is, it is in particular an object of the present invention to provide a filtering unit and a method of filtration, which are simplified and at the same time can be used for different filtering implementations.

These and other objects, which become apparent upon reading the following description, are solved by the subject matter of the independent claims. The dependent claims refer to preferred embodiments of the invention.

### 3. SUMMARY OF THE INVENTION

According to a first aspect of the invention, a filtering unit is provided, which comprises: a first cavity with a first filtering technology for filtering a liquid, and with a first outlet for dispensing the liquid filtered by the first filtering technology; and a second cavity with a second filtering technology, which is different from the first filtering technology, for filtering a liquid, and with a second outlet for dispensing the liquid filtered by the second filtering technology. The first cavity and the second cavity are integrated in a same unit.

Since the first cavity and the cavity are integrated in the same unit, the design is made simpler, while at the same time providing different implementations for different filtering needs. For example, providing or installing the first cavity with the first filtering technology provided in the same unit effects that at the same time the second cavity with the second filtering technology is provided or installed. As such, it is not required to modify or replace the filtering unit, when an implementation different from the liquid filtering with the first filtering technology is desired. The filtering unit thus enables to selectively use, for filtering a liquid, the first filtering technology or the second filtering technology, or both the first filtering technology and (simultaneously) the second filtering technology. Also, the integration in the same cavity effects that when one of the cavities is handled, such as by a user for installing the filtering unit, at the same time the other one of the cavities is handled. Thus, a simple design for providing different filtering technologies is achieved. For example, the filtering unit comprises a wall or wall portion, wherein both the first cavity and the second cavity are integral with this wall or wall portion in order to provide the same unit.

In other words, the filtering unit provides, in a single unit or enclosure, different filtering technologies, i.e. at least the first filtering technology and the second filtering technology and preferably further (i.e. a third, fourth, etc.) filtering technologies, so that the filtering unit is, in particular, adapted to select one or more of the filtering technologies for filtering the liquid. A filtering unit or device is thus provided that is simplified and at the same time can be used for different filtering implementations.

The first filtering technology may be adapted to filter impurities, such as pathogens and/or organic pollutants and contaminants, and/or substances affecting the taste and/or odor of the liquid, such as chlorine. Pathogens are also called “germs”; a pathogen is an infectious microorganism or agent, such as a virus, bacterium, or fungus, that may produce a disease. Organic pollutants and contaminants may be substances, which do not immediately produce a disease as for pathogens, but may have in the long-term an effect on human's health; for example, organic pollutants/contaminants include organic compounds that are resistant to environmental degradation through chemical, biological, and photoelectric processes; in particular, the organic pollutants and contaminants may include persistent organic pollutants (POP), for example those listed on the Stockholm Convention List on persistent organic pollutants. Hence, the first outlet dispenses a liquid with a reduced amount of impurities and/or substances so that, in particular, the liquid does not cause problems (such as health and/or technical problems) and/or fulfills a certain quality, such as of drinking water. Preferably, first filtering technology is adapted to filter the impurities and/or (other) substances, while preserving the minerals content originally dissolved in the liquid. Preserving the minerals content is advantageous in order to have healthy benefits when consuming the liquid with the preserved minerals.

The first cavity comprises an activated carbon filtering means for providing (or effecting) the first filtering technology. The activated carbon filtering means provide a particular good filtration performance. In one example, the first cavity may comprise only the activated carbon filtering means for providing the first filtering technology.

The second filtering technology may be adapted to filter impurities, such as pathogens and/or organic pollutants and contaminants, and/or substances affecting the taste and/or odor of the liquid, such as chlorine. Hence, the second outlet dispenses a liquid with a reduced amount of impurities and/or substances so that, in particular, the liquid does not cause problems (such as health and/or technical problems) and/or fulfills a certain quality, such as of drinking water. Preferably, the second filtering technology is adapted to filter the impurities and/or (other) substances, while preserving the minerals content originally dissolved in the liquid. Preserving the minerals content is advantageous in order to have healthy benefits when consuming the liquid with the preserved minerals. Additionally or alternatively, the second filtering technology may be adapted to remove and/or exchange heavy metals (in particular heavy metals that are toxic in a small or larger amount and/or in a certain form; heavy metals are, for example, iron, copper, lead, cadmium, and/or mercury) in the liquid.

The second filtering technology may be adapted to remove and/or exchange minerals, such as calcium and/or magnesium, in order to reduce the liquid hardness. The liquid dispensed by the second outlet can thus be used in implementations, which require a soft liquid hardness, in particular to prevent scale formation. For example, the liquid dispensed by the second outlet is advantageously liquid to be heated. Hence, liquid can be heated, while having a reduced scale formation (and thus reduced technical problems due to scale formation, e.g. in a heating unit) due to the lower liquid hardness reduced by the second filtering technology.

The second cavity may comprise an ion exchange resin and activated carbon filtering means for providing the second filtering technology. The ion exchange resin in particular improves the capability of the second filtering technology for liquid softening (i.e. the ion exchange resin is used to replace the magnesium and/or calcium ions found in the (hard) liquid with sodium ions) and/or liquid purification (i.e. the ion exchange resin is used to replace impurities with more innocuous ions, such as sodium and potassium). In combination with the activated carbon filtering means, the second filtering technology has, furthermore, a high filtration performance. In one example, the second cavity may comprise (only) the ion exchange resin and activated carbon filtering means for providing the second filtering technology in order to have the second filtering technology different from the first filtering technology.

The first cavity may comprise a first filtering structure extending along a first length and for providing (or effecting) the first filtering technology, and wherein the second cavity may comprise a second filtering structure extending along a second length and for providing (or effecting) the second filtering technology, wherein the first length is greater than the second length, or wherein the second length is greater than the first length. Hence, a compact filtering unit is provided, which at the same time effects an effective filtration. The respective filtering structure extending along at least part of the difference between the lengths may effect respective filtering capabilities, which, for example, make the second filtering technology different from the first filtering technology. In particular, the shape and/or size of the cavities and, thus, of the respective filtering structures may be adapted for the respective filtration effects. For example, the second filtering structure, and thus the second cavity, may be smaller in size than the first filtering structure, and thus the second cavity, since the amount (volume) of liquid to be filtered by the second filtering technology (e.g. a liquid for a hot beverage) is less than the amount (volume) of liquid to be filtered by the second filtering technology. The first length may extend along a first longitudinal axis and the second length may extend along a second longitudinal axis, wherein these axes are preferably parallel to one another; thus, the compactness of the filtering unit can be improved.

Preferably, the cavities are integrated in the same unit is such a way that the filtering unit can be connected to and/or at least partially arranged in a same liquid source, such as a discharge opening, e.g. a discharge opening or spout of a tap, and/or a liquid tank, so that liquid from the same liquid source can be fed to the cavities in order to be filtered. Consequently, the liquid from the same liquid source can be selectively filtered by the first filtering technology or the second filtering technology or by both the first filtering technology and the second filtering technology. When the filtering unit is connected to and/or at least partially arranged in the liquid tank as the same liquid source, and when the liquid tank contains liquid, the filtering unit may be at least partially (and preferably completely) immersed in the liquid contained in the liquid tank.

According to a second aspect of the invention, a system is provided that comprises a liquid tank and a filtering unit according to any one of the preceding claims. Hence, the filtering unit can be arranged to filter the liquid contained in the liquid tank. The system may comprise the liquid tank and the filtering unit such that the liquid tank encloses the filtering unit.

The filtering unit may be arranged on the liquid tank and/or at least partially or completely inside of the liquid tank. In other words, the liquid tank delimits a space for containing the liquid, wherein the filtering unit may be arranged at least in part or completely inside of this space. As such, when the space contains the liquid, the filtering unit is at least in part immersed in the liquid in order to filter, by the first filtering technology and second filtering technology, this liquid. The system has thus, in particular, a reduced size.

The liquid tank may be adapted to arrange the filtering unit in a specific position and/or orientation, so that only in this position and/or orientation the filtering unit is functionally connected to the liquid tank for filtering liquid contained in the liquid tank. The liquid tank is thus designed to avoid a positions and/or orientations of the filtering unit with respect to the liquid tank, which may cause a malfunction between the liquid tank and the filtering unit. The system may thus be “mistake-proof” with respect to functionally connecting the liquid tank and the filtering unit with one another.

The liquid tank may comprise one or more sections adapted, in particular shaped and/or sized, to cooperate with the first cavity and/or second cavity in such a way that the filtering unit is arranged in the specific position and/or orientation. Thus, the “mistake-proof” design of the system can be easily provided. For example, the one or more sections may be correspondingly and/or complementary formed to a part of the first cavity and/or second cavity. Thus, the complementary or correspondingly formed part of the one or more sections cooperates with the first cavity and/or second cavity such that the filtering unit can be guided to have the specific position and/or orientation relative to the liquid tank.

According to a third aspect of the invention, a beverage system for producing a beverage is provided. The beverage system may be adapted to produce the beverage from a container, such as from a capsule; the container may comprise a beverage additive, e.g. for providing a specific flavor and/or function. The beverage system comprises a filtering unit as described above or a system as described above, wherein the first outlet is connectable to a primary discharge line, and wherein the second outlet is connectable to a secondary discharge line.

The beverage (preparation) system is in particular adapted to dispense different beverages, requested (on demand) by a consumer or user of the system. For example, if the beverage system is controlled to dispense a hot beverage, the liquid for producing this beverage may be filtered by the second cavity to reduce at least substances (such as calcium and/or magnesium) that may cause technical problems when heated up. The filtered liquid may then be dispensed by the second outlet into the secondary discharge line, where it is at least heated up, and dispensed into a container (e.g. a cup) for consumption. Similarly, if the beverage system is controlled to dispense a cold beverage (e.g. at or below room temperature), the liquid for producing this beverage may be filtered by the first cavity to reduce certain substances (impurities, pathogens, etc.) but not substances that may cause technical problems when heated up, such as calcium and/or magnesium; that is, these substances may then purposely not filtered due to the healthy characteristics. The filtered liquid may then be dispensed by the first outlet into the first discharge line, where it is not heated up but, for example, carbonated and/or flavored, and dispensed into a container for consumption.

The beverage system may be also adapted to a prepare a beverage made of at least both liquid, which is filtered by the first cavity and dispensed by the primary discharge line, and liquid, which is filtered by the second cavity and dispensed by the secondary discharge line. In the prepared beverage, the liquid filtered by the first cavity may represent the main liquid in the beverage, such as from 80 to 95 vol. %, preferably about 90 vol. %, of the liquid contained in the beverage. The liquid filtered by the second cavity may represent a minor liquid in the beverage and/or may represent from 5 to 20 vol. %, preferably about 10 vol. %, of the liquid contained in the beverage Preferably, the beverage system comprises the primary discharge line and the secondary discharge line, such as in the form of at least a first tube and at least a second tube, respectively, wherein the beverage system further comprises a heating unit arranged to heat the liquid flowing through (or in) the secondary discharge line.

The heating unit may be a boiler. The heating unit facilitates the production of a hot beverage and/or may be used for a sanitization (reduction of biofilm and/or germ formation, etc.) of the beverage system, e.g. by circulating heated up liquid.

According to a third aspect of the invention, a method of filtration is provided, the method comprising the following steps: filtering, with a first filtering technology arranged in a first cavity, a first amount of liquid; dispensing, with a first outlet provided by the first cavity, the first amount of liquid filtered by the first filtering technology; filtering, with a second filtering technology arranged in a second cavity and that is different from the first filtering technology, a second amount of liquid; and dispensing, with a second outlet provided by the second cavity, the second liquid filtered by the second filtering technology. The first cavity and the second cavity are integrated in a same unit, wherein the first amount of liquid and the second amount of liquid are preferably from a same liquid source.

### 4. BRIEF DESCRIPTION OF DRAWINGS

In the following, the invention is described exemplarily with reference to the enclosed figures, in which

FIG. 1 shows a schematic lateral side view of a filtering unit according to a preferred embodiment of the invention;

FIG. 2 shows a schematic perspective view of a system according to a preferred embodiment, wherein the system comprises the filtering unit shown in FIG. 1;

FIG. 3 shows a schematic cross-sectional view of the system shown in FIG. 2;

FIG. 4 shows a schematic perspective view of a filtering unit according to a further preferred embodiment of the invention;

FIG. 5 shows a schematic cross-sectional view of the filtering unit shown in FIG. 4;

FIG. 6 shows a schematic perspective view of a system according to a further preferred embodiment of the invention, which comprises the filtering unit according to FIG. 4;

FIG. 7 shows a schematic perspective detailed view of the filtering unit in FIG. 4, in which the side (i.e. bottom) of the filtering unit with the outlets is shown;

FIG. 8 shows a schematic perspective view of a connector that can be coupled to the outlets of the filtering unit; and

FIG. 9 shows a schematic view of a beverage system according to a preferred embodiment of the invention, wherein the beverage system exemplarily comprises the system shown in FIG. 3.

### 5. DETAILED DESCRIPTION

FIGS. 1 to 3 show a first preferred embodiment of a filtering unit 70. The filtering unit 70 comprises a first cavity 71 with a first filtering technology for filtering a liquid. The liquid may be, for example, water. Thus, the first cavity 71 can be fed with the liquid to be filtered. The first cavity 71 may comprise a first inlet 72 so that via the inlet 72 liquid can be fed to the first cavity 71 in order to be filtered by the first filtering technology. The first inlet 72 may comprise one or more inlet openings, e.g. in the form of one or more slits; the slits may extent longitudinally and/or parallel to one another. Preferably, the inlet 72 is formed in a wall 73 of the first cavity 71. The wall 73 is, for example, a lateral side wall, which extends from a bottom, such as from a bottom wall 74, to a top, such as to a top wall 75, of the first cavity 71.

The first filtering technology, provided by the first cavity 71, is adapted to filter a liquid, such as water. That means that the first filtering technology is adapted to separate certain substances from the liquid so that the so filtered liquid comprises at least a reduced amount of these specific substances. For example, the first filtering technology is adapted to filter impurities. The impurities may comprise pathogens, and/or organic pollutants and contaminants. Additionally or alternatively, the first filtering technology may be adapted to filter substances that affect the taste and/or odor of the liquid. That is, these substances may not affect the health or produce a disease, but may be disadvantageous for the consumption experience of the liquid. For example, these substances include chlorine. Preferably, the first filtering technology is adapted to preserve the minerals content originally dissolved in the liquid, when the liquid is filtered. That means that the minerals are not separated from the liquid so that a consumer of the liquid can benefit from these minerals.

In order to provide the first filtering technology, a first filtering structure may be provided, such as at least partially arranged inside of the first cavity 71. The first cavity 71 may be designed to at least partially enclose, such as with one more of the walls 73, 74, 75, the first filtering structure. The first cavity 71 may be adapted such that the first filtering structure can be attached to (or in) and removed from the first cavity 71. This is advantageous for an easy maintenance of the first filtering technology, such as when the filter performance (or capacity) of the first filtering structure is reduced and requires a maintenance or replacement. For example, the first cavity 71 may be separable in a plurality of parts in order to provide access to the first filtering technology, e.g. first filtering structure. In a particularly preferred embodiment, an activated carbon filtering means provides the first filtering technology, i.e. the first filtering structure then comprises an activated carbon filtering means. The activated carbon filtering means, also called carbon filtering, comprises a bed of activated carbon that removes the impurities (or other unwanted substances) from the liquid using adsorption. Thus, the impurities in the liquid to be filtered are trapped inside of a pore structure of the carbon substrate.

The first cavity 71 further comprises a first outlet 76 for dispensing the liquid filtered by the first filtering technology. That is, liquid is fed, e.g. via the inlet 72, to the first cavity 71, filtered by the first filtering technology and, after being filtered, dispensed via the first outlet 76. In other words, with respect to a flow direction of a liquid flowing through the first cavity 71 in order to be filtered, the first outlet 76 is arranged downstream of the first filtering technology or first filtering structure, wherein the (first) inlet 72 is arranged upstream of the first filtering technology or first filtering structure. The bottom of the first cavity 71 may comprise the first outlet 76. Additionally or alternatively, the first outlet 76 may be arranged on and/or may be formed in a wall, such as the bottom wall 74, of the first cavity 71. The first outlet 76 may be shaped and/or sized to be connectable to a liquid dispensing system, such as to an inlet of the liquid dispensing system. The first outlet 76 may be at least partially provided by an opening and/or a hollow cylinder, preferably comprising the opening. The first outlet 76 may comprise a fastening element for fastening the first outlet 76 to an inlet, such as of a liquid dispensing system or a beverage (production) system, e.g. as described further below. The first outlet 76 may have a visual element, such as a graphic indication, for indication.

The filtering unit 70 further comprises a second cavity 77 with a second filtering technology for filtering a liquid (e.g. water). Thus, the second cavity 77 can be fed with the liquid to be filtered. The second cavity 77 may comprise a second inlet 78 so that via the inlet 78 the liquid is fed to the second cavity 77 in order to be filtered by the second filtering technology. The second inlet 78 may comprise one or more inlet openings, e.g. in the form of one or more slits; these slits may extent longitudinally and/or parallel to one another. Preferably, the inlet 78 is formed in a wall 79 of the second cavity 77. The wall 79 is, for example, a lateral side wall, which extends from a bottom, such as from a bottom wall 80, to a top, such as to a top wall 81, of the second cavity 77. For example, the first inlet 72 is arranged on a first side (such as the left side) of the filtering unit 72, wherein the second inlet 78 is arranged on a second side (such as a right side) of the filtering unit 72, which second side faces away from the first side.

The second filtering technology is different from the first filtering technology. That means that the second filtering technology may have the capability of filtering certain substances, which cannot be filtered by the first filtering technology. Additionally or alternatively, in order to be different from the first filtering technology, the second filtering technology may not have the capability of filtering certain substances, which however can be filtered by the first filtering technology. In general, the second filtering technology may be adapted to filter a liquid, such as water. That means that the second filtering technology is adapted to separate certain substances from the liquid so that the filtered liquid comprises a reduced amount of these specific substances. For example, the second filtering technology is adapted to filter impurities such as pathogens. Additionally or alternatively, the impurities, which can be filtered with the second filtering technology, include organic pollutants and contaminants. Additionally or alternatively, the second filtering technology may be adapted to filter substances that affect the taste and/or odor of the liquid.

The second filtering technology may be adapted to preserve the minerals content originally dissolved in the liquid, when the liquid is filtered. That means that minerals are not separated from the liquid so that a consumer of the liquid can benefit from these minerals. Preferably, the second filtering technology is adapted to remove and/or exchange minerals, such as calcium and/or magnesium, in order to reduce the liquid hardness. This reduces the technical problems caused by hard liquid, i.e. scale, in particular when the second filtering technology is provided for filtering liquid that is to be heated up. Preferably, the second filtering technology is adapted to remove and/or exchange heavy metals in the liquid. For example, out of the first filtering technology and the second filtering technology, only the second filtering technology is adapted to remove and/or exchange heavy metals in the liquid. Heavy metals include, for example, iron, copper, lead, cadmium, and/or mercury.

In order to provide the second filtering technology, a second filtering structure may be provided, such as at least partially arranged inside of the second cavity 77. The second cavity 77 may be designed to at least partially enclose, such as with one more of the walls 79, 80, 81, the second filtering structure. The second cavity 77 may be adapted such that the second filtering structure can be attached to (or in) and removed from the second cavity 77. This is advantageous for an easy maintenance of the second filtering technology or second filtering structure, e.g. when the filter performance (or capacity) is reduced. For example, the second cavity 77 may be separable in order to provide access to the second filtering technology, e.g. second filtering structure.

In a particularly preferred embodiment, an activated carbon filtering means provides, at least in part, the second filtering technology, i.e. the second filtering structure then comprises an activated carbon filtering means. Preferably, the second cavity comprises an ion exchange resin for, at least in part, providing the second filtering technology. The ion exchange resin is in particular advantageous for reducing the liquid hardness and/or the impurities in the liquid. That is, the ion exchange resin replaces the magnesium and calcium ions found in the (hard) liquid with sodium ions, thereby reducing the liquid hardness, and/or the ion exchange resin replaces impurities with more innocuous ions, such as sodium and potassium, thereby purifying the liquid. For example, the liquid structure comprises (or consists of) a first section dedicated for and comprising (or consisting of) the activated carbon filtering means, and a second direction dedicated for and comprising (or consisting of) the ion exchange resin. The first section and the second section may be integrated with one another or separated from one another. For example, the second cavity 77 comprises a first compartment, in which the first section is arranged, and a second compartment, in which the second section is arranged. As such, one of the sections may be removed from the cavity 77, independent of the other section, which is in particular advantageous for maintenance purposes.

In order to provide the second filtering technology to be different from the first filtering technology, the second filtering structure may be different from the first filtering structure. For example, the second filtering structure may comprise filtering means, such as the ion exchange resin, which the first filtering structure does not comprise. In other words, only the second cavity may comprise an ion exchange resin in order to provide, at least in part, the second filtering technology. The second filtering technology may also (spatially) extend differently than the first filtering structure in order to effect that the second filtering technology is different from the first filtering technology. As shown in, for example, FIG. 1, the first filtering structure may extent along a first length, and the second filtering structure may extent along a second length, wherein the first length is greater than then the second length, or vice versa. As such, the second filtering structure may be, compared to the first filtering structure, downsized, whereas the first filtering structure has a higher filtration performance than the second filtering structure. Such a configuration may be provided for the reason that the liquid filtered by the first filtering technology is, after being dispensed by the first outlet 76, less subject to purification and/or sanitization, compared to the filtered liquid dispensed by the second outlet 82. The liquid, which is filtered by the second filtering structure with a lower filtering performance and subsequently dispensed via the second outlet 82, may be subject to a further purification and/or sanitization process, e.g. provided by heating the liquid.

If the second length is greater than then the first length, the part of the second filtering structure extending along the difference between these lengths may comprise a specific filtering structure or filtering capability, such as a filtering structure or capability adapted to remove and/or exchange minerals (calcium and/or magnesium, etc.) in order to reduce the liquid hardness. At least this specific filtering structure may then make the second filtering structure different from the first filtering structure.

The second cavity 77 comprises a second outlet 82 for dispensing the liquid filtered by the second filtering technology. That is, liquid is fed, e.g. via the inlet 78, to the second cavity 77, filtered by the second filtering technology and, after being filtered, dispensed via the second outlet 82. In other words, with respect to a flow direction of a liquid flowing through the second cavity 77 in order to be filtered, the second outlet 82 is arranged downstream of the second filtering technology or second filtering structure, wherein the (second) inlet 78 is arranged upstream of the second filtering technology or second filtering structure. The bottom of the second cavity 77 may comprise the second outlet 82. Additionally or alternatively, the second outlet 82 may be arranged on and/or may be formed in a wall, such as the bottom wall 80, of the second cavity 77. The second outlet 82 may be shaped and/or sized to be connectable to a liquid dispensing system, such as to an inlet of the liquid dispensing system. The second outlet 82 may be at least partially provided by an opening and/or a hollow cylinder, preferably comprising the opening. The second outlet 82 may comprise a fastening element for fastening the second outlet 82 to an inlet, such as of a liquid dispensing system or a beverage (production) system, e.g. as described further below. The first outlet 76 may have a visual element, such as a graphic indication, for indication.

The first outlet 76 and the second outlet 82 are preferably distanced from one another. The first outlet 76 and the second outlet 82 may be arranged such that the outlets 76, 82 dispense the liquid to a same side. The first outlet 76 may dispense liquid along a first direction, and the second outlet 82 may dispense liquid along a second direction, wherein these directions may be directed along a same direction and/or may be parallel to one another. For example, the first outlet 76 is arranged adjacent to the second outlet 82.

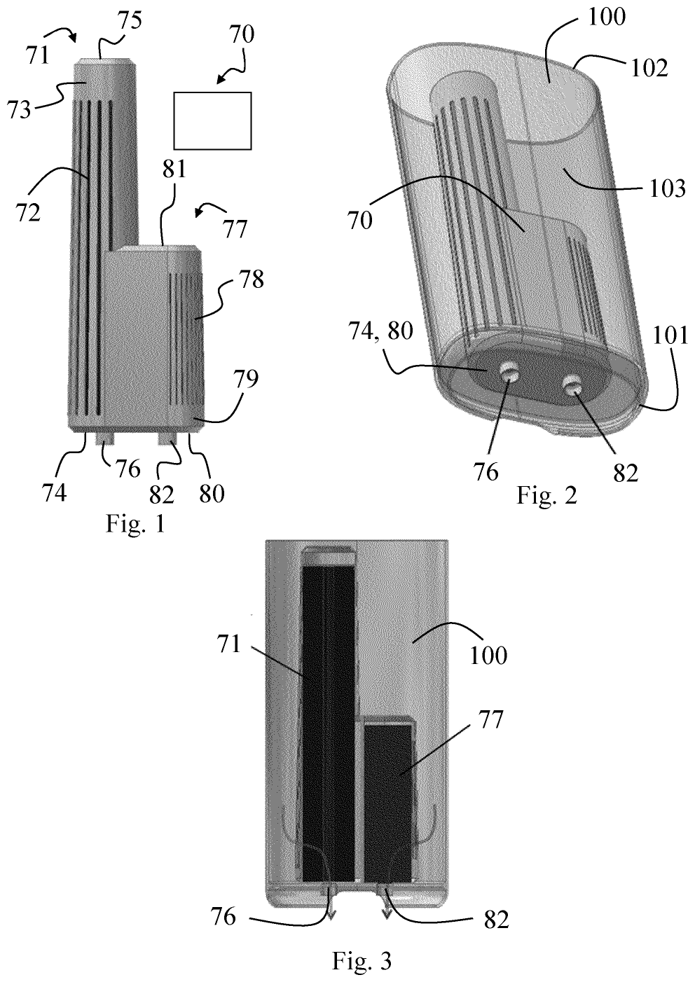

According to the invention, the first cavity 71 and the second cavity 77 are integrated in a same unit. For example, the cavities 71, 77 are integrated in the same unit in such a way that the filtering unit 70 can be connected to and/or at least partially (preferably completely) arranged in a same liquid source so that the cavities 71, 77 can be fed with liquid from this same liquid source. As shown in FIG. 2, the same liquid source may be a liquid tank 100. In other examples, the same liquid source may be a discharge opening, e.g. a discharge opening or spout of a tap. In order to be integrated in the same unit, one or more walls of the first cavity 71 may be integral with one or more walls of the second cavity 77. In other words, the filtering unit 70 may comprise at least one wall that forms both at least part of the first cavity 71 and at least part of the second cavity 77. For example, in order to integrate the cavities 71, 77 in the same unit, the bottom wall 74 may be integral with the bottom wall 80. Preferably, the filtering unit 70 comprises a wall that forms both the bottom wall 74 and bottom wall 80 in order to integrate the cavities 71 and 73 in the same unit. Additionally or alternatively, the side wall 73 and/or bottom wall 74 and/or top wall 75 of the first cavity 71 may be integral with the side wall 79 and/or bottom wall 80 and/or top wall 81 of the second cavity 77 in order to integrate the first cavity 71 and the second cavity 77 in the same unit.

FIGS. 2 and 3 exemplarily show a system that comprises a filtering unit 70, as described above, and a liquid tank 100. The filtering unit 70 is arranged such that both the first cavity 71 and the second cavity 77 can be fed with liquid contained in the liquid tank 100. The liquid tank 100 may comprise a bottom or bottom wall 101, a top or top wall 102, and one or more side walls 103, wherein the one or more side walls 103 may extend from the bottom or bottom wall 101 to the top or top wall 102. The bottom wall 101, top wall 102 and the one or more side walls 103 may delimit a space, in which the liquid tank 100 contains the liquid. The liquid tank 100 may store a defined amount of liquid, such as between 1 and 6 l, preferably 3 l. The liquid tank 100 may be refillable with liquid, such as by way of the top or top wall 102.

The filtering unit 70 is not limited to a specific arrangement with respect to the liquid tank 100. For example, the filtering unit 70 may be arranged at least partially or completely inside of the liquid tank 100. As such, when the liquid tank 100 is filled with a liquid, the filtering unit is at least partially or completely immersed in this liquid in order to be fed with this liquid for filtering. The outlets 76, 82 of the filtering unit 70 are preferably arranged such that they can dispense the filtered liquid out of the liquid tank 100, such as by way of the bottom or bottom wall 101. In particular, the outlets 78, 82 may be arranged closer to the bottom than to the top of the liquid tank 100.

For facilitating an easy assembly, the liquid tank 100 may be adapted to arrange the filtering unit 70 in a specific position and/or orientation with respect to the liquid tank 100. Only in this specific position and/or orientation, the filtering unit 70 is then functionally connected to the liquid tank 100 for filtering liquid contained therein. For example, in this specific position and/or orientation, at least the inlets 72, 78 are fully immersed in the liquid contained in the liquid tank 100. In the specific position and/or orientation, the outlets 26, 82 may be arranged such that they can (functionally correct) dispense the filtered liquid out of the liquid tank 100. For arranging the fluid unit 70 in the specific position and/or orientation by the liquid tank 100, the liquid tank 100 may comprise one or more sections adapted, in particular shaped and/or sized, to cooperate with the first cavity 71 and/or the second cavity 77. This corporation between the liquid tank 100 and the fluid unit 70 may designed (e.g. shaped and/or sized) to guide the filtering unit 70 into the specific position and/or orientation.

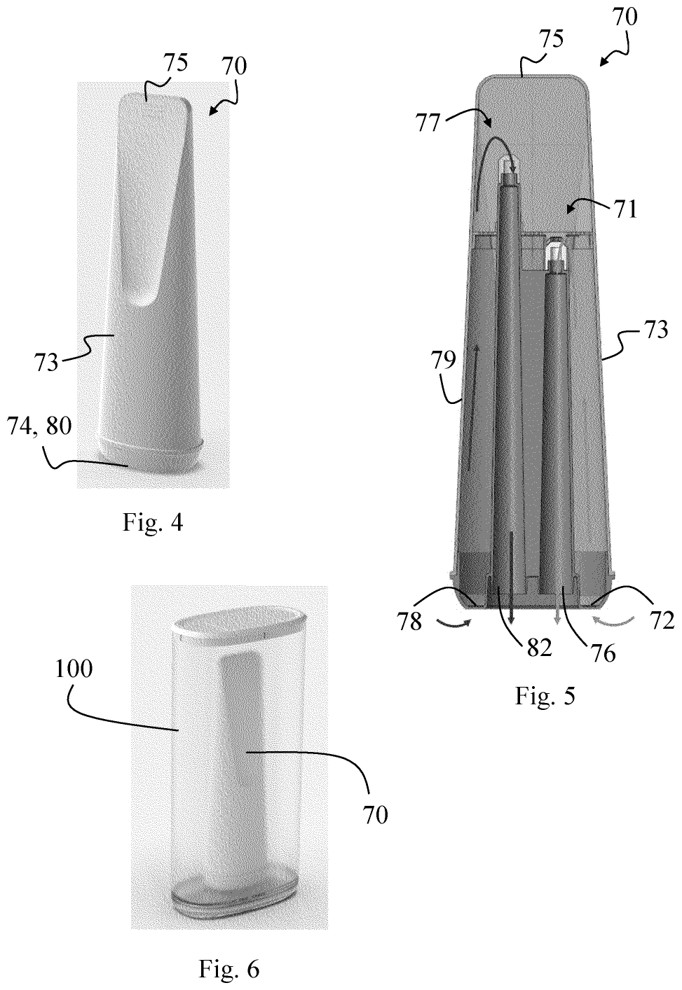

In FIGS. 4 to 6, a further preferred embodiment of a filtering unit 70 is shown. Same reference numerals correspond to same features. The embodiment shown in these figures differs from the embodiment shown in FIGS. 1 to 3 in that the inlets 72, 78 are arranged differently. In particular, the inlets 78, 82 are not arranged in the side walls 73, 78, but at the bottom of the filtering unit 70. The bottom may comprise a ring for attaching (e.g. bonding) the bottom to the side walls 73, 78. For example, liquid can then both enter (unfiltered) and exit (filtered) the filtering unit 70 via the bottom. For example, both the inlets 78, 82 and the outlets 76, 82 are arranged at the bottom of the filtering unit 70. When viewed onto the bottom of the filtering unit 70, the outlets 76, 82 may be arranged between the inlet 78 and the inlet 82. As shown in FIG. 5, the filtering unit 70 may be adapted such that liquid can enter, via the inlet 78, 82, the filtering unit 70, flows along the side walls 73, 78, respectively, and—for example while flowing along the side walls 73, 78—is filtered by the first filtering technology and the second filtering technology, respectively.

The filtering unit 70 may, as exemplarily shown in FIG. 5, comprise a lower part and an upper part, wherein the first filtering structure of the first cavity 71 extends only in the lower part, and wherein the second filtering structure of the second cavity extends both in the lower part and the upper part. The part of the second filtering structure extending in the upper part may have specific filtering capabilities, such as of removing and/or exchanging minerals (calcium and/or magnesium, etc.) in order to reduce the liquid hardness; this part of the second filtering structure may then make the second filtering technology different from the first filtering technology. For example, the lower part may be adapted to provide the first filtering structure and part of the second filtering structure, wherein the upper part then provides a further part of the second filtering structure. Thus, the first filtering structure and part of the second filtering structure may be provided by a same (or common) filtering structure. Thus, the liquid flows from the bottom of the filtering unit 70 to the top of the filtering unit 70 and, subsequently, flows words the bottom of the filtering unit 70 in order to be filtered with the first filtering technology and second filtering technology, respectively.

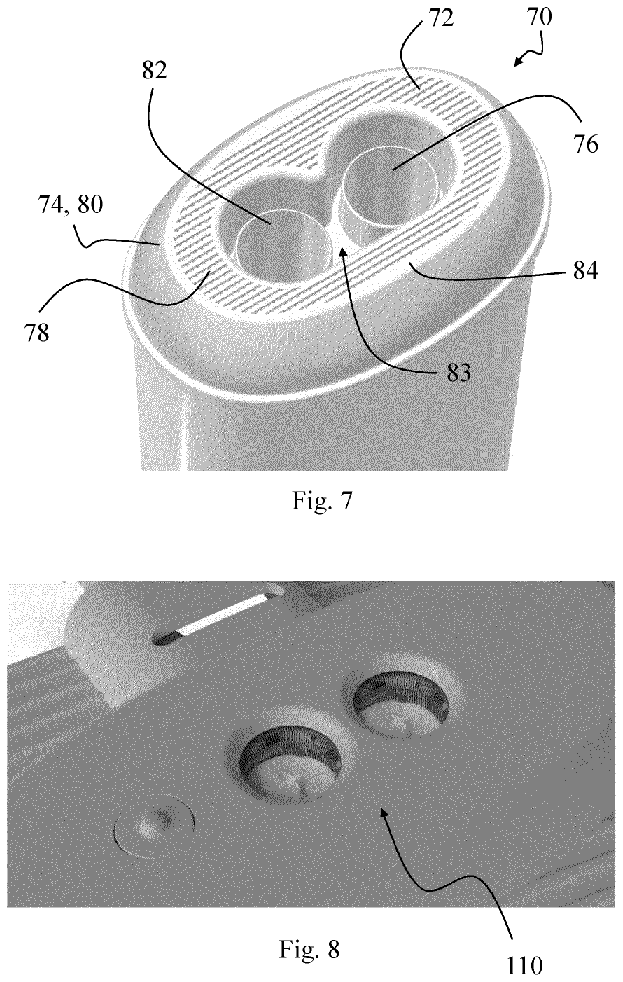

As shown in FIG. 7 in more detail, the bottom of the filtering unit 70 may comprise a recessed portion 83, in which the outlets 76, 82 are arranged. Preferably, the inlets 72, 78 are arranged outside of this recessed portion 83 and/or are arranged to surround this recessed portion 83. For example, the bottom or bottom wall of the filtering unit 70 comprises a surface 84, in which the recessed portion is formed, wherein the inlets 78, 82 are formed in this surface 84. FIG. 8 exemplarily shows an inlet 110 that can be connected to the outlets 76, 82. The inlet 110 may be correspondingly or complementary formed to the outlets 76, 82 and/or may adapted to sealingly connect to the outlets 76, 82. For example, the inlet 110 comprises one or more sealing elements that are arranged to seal a gap between the inlet 110 and the outlets 76, 82, respectively in order to prevent leakage.

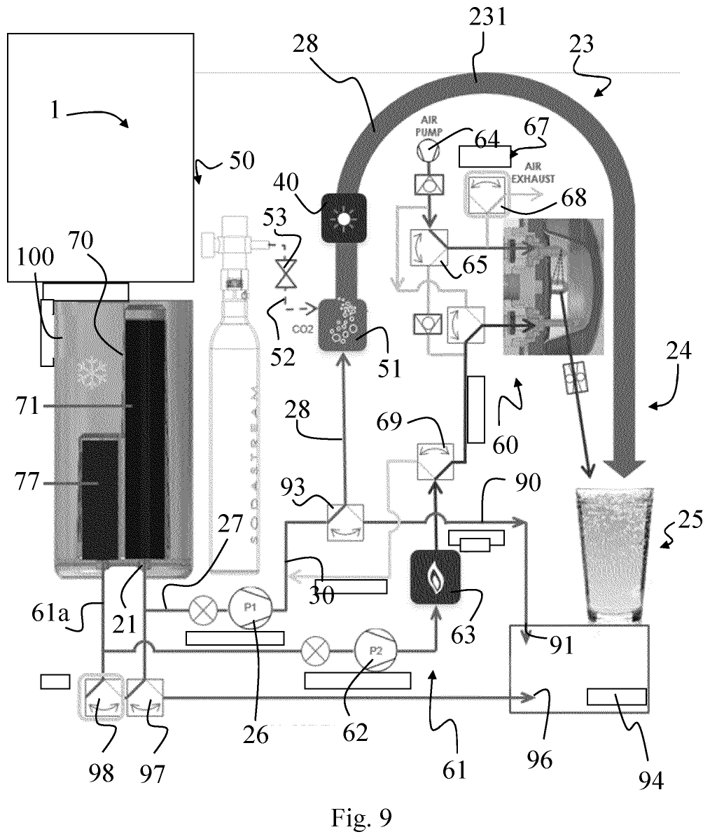

FIG. 9 exemplarily shows a beverage system 1 (i.e. a beverage preparation device 1 or water system) according to a preferred embodiment of the invention that comprises the filtering unit 70 or system 100 as described above. Other implementations of the filtering unit 70 are also possible, such as a (liquid dispensing) system that comprises a discharge opening for discharging liquid (e.g. water), such as a discharge opening of a tap, and the filtering unit 70 arranged to filter the liquid discharged by the discharge opening.

In FIG. 9, the beverage system 1 may be adapted for being used by a consumer, who requests (on demand) a beverage from the beverage system 1. That is, the beverage system 1 may be adapted to discharge a beverage that is ready for drinking by the consumer, i.e. a ready-to-drink beverage. The beverage system 1 is not limited to a specific design. Preferably, the beverage system 1 is designed to be used on the side of a business (B2B) and/or on the side of a customer (B2C). For example, the beverage system 1 may be designed as a vending machine (airport, mall, public area, etc.), in B2B (hotel, restaurant, café, i.e. “HoReCa”, fitness center, office, etc.) and/or B2C (e.g., at home). The beverage system 1 may be designed as a vending machine, a water dispenser, and/or a home appliance device. The beverage system 1 may be designed for being mounted or positioned to a wall (wall-mounted), a bottom, and/or a tabletop, and/or the beverage system 1 may have a freestanding design. The beverage system 1 may comprise a connection for a power supply in order to supply the respective components of the beverage system 1 with electrical energy.

The beverage system comprises a (primary) discharge line 23 for discharging liquid via a discharge outlet 24. The discharge outlet 24 may be arranged such that liquid flowing through the discharge outlet 24 is discharged out of the beverage system 1, such as into a container 25 (e.g. a cup) positioned downstream of the discharge outlet 24 with respect to a flow from the discharge line 23 to the discharge outlet 24. The discharge outlet 24 may be arranged such that the flow of liquid exiting the discharge outlet 24 can (e.g. directly) enter the container 25, which is, for example, positioned on a support of the beverage system 1. For example, the discharge outlet 24 is positioned opposite and/or above said support. The discharge line 23 may comprise a liquid inlet 21. Byway of the liquid inlet 21, liquid can be delivered into the discharge line 23. The discharge line 23 is not limited to a specific design or arrangement. Preferably, the discharge line 23 extends in a straight, angled and/or arcuate manner. As can be seen in FIG. 9, the discharge line 23 may partially extend in an arcuate manner. The discharge line 23 may comprise a section 231. The section 231 may be arranged such that liquid, which is to be discharged via the discharge outlet 24, is required to have enough energy to flow beyond this section 231 and subsequently out of the discharge outlet 24. If the discharge line 23 is at least in part designed in an angled and/or arcuate manner, the section comprising the arch (or bend) may then comprise the section 231.

The discharge line 23 may be composed of a first section 28 and a second section 27, 30. The first section 28 may be the part of the discharge line 23, which comprises the discharge outlet 23. The first section 28 may thus comprise the arcuately extending part of the discharge line 23 and/or may comprise the section 231. The first section 28 may comprise also a part of the discharge line 23, which may extend in a substantially straight and/or vertical manner. The second section 27, 30 may be composed of an inlet line 27 and a delivery line 30. The second section 27, 30, such as the inlet line 27, preferably comprises the liquid inlet 21 so that via the liquid inlet 21 liquid can enter the second section 27, 30 respectively inlet line 27. Thus, liquid can be delivered into the second section 27, 30 (for example into the inlet line 27 and subsequently into the delivery line 30) and subsequently into the first section 28 to be finally discharged from the discharge outlet 24.

The beverage system 1 may comprise a pump 26 (i.e. a main pump) to circulate liquid selectively along the discharge line 23 and towards the discharge outlet 24 and finally out of the discharge outlet 24. The pump 26 may be arranged to pump the liquid such that the liquid (still or sparkling), which is discharged out of the discharge outlet 24, has a specific flow rate, which is, for example, in the range from 1 l/min to 3 l/min, preferably 2 l/min. The pump 26 is preferably arranged at a position along the discharge line 23, for example next to the liquid inlet 21 of the discharge line 23 and/or at the delivery line 30. The pump 26 preferably provides a flow rate or energy to the liquid so that this liquid can flow beyond the section 231 and subsequently out of the discharge outlet 24. The pump 26 may be a pump, which can deliver liquid in two directions, which are opposite to one another, i.e. along the discharge line 23 and towards (first direction) and away from (second direction) the discharge outlet 24. For example, the pump 26 is a gear pump.

The filtering unit 70 is, with the first outlet 76, functionally connectable or connected to the (primary) discharge line 23, e.g. via the liquid inlet 21 of the discharge line 23. Thus, liquid, filtered by the first filtering technology of the filtering unit 70, is delivered or dispensed into the discharge line 23, such as by operating the pump 26.

The filtering unit 70 or the system, which comprises the filtering unit 70 and the liquid tank 100, may be detachably provided with respect to the beverage system 1. For example, a user of the beverage system 1 may detach the filtering unit 70 and/or (e.g. empty) liquid tank 100, such as in order to subsequently attach a new filtering unit 70 and/or new (e.g., filled) liquid tank 100 to or in the beverage system 1. Alternatively, the beverage system 1 may comprise a port (a liquid connection) adapted to connect with a liquid network, such as with an outlet for mains liquid (tap liquid), wherein the filtering unit 70 is arranged to filter the liquid discharged by this port. Thus, by having the port, the beverage system 1 is not required to be comprise as a liquid tank, since the port can directly feed the filtering unit 70 with liquid to be filtered and subsequently delivered, such as with the first outlet 76, into the discharge line 23.

Drawing of the liquid from the liquid source, e.g. the liquid tank 100, for filtering with the filtering unit 70 and for circulating the filtered liquid along the discharge line 23 is preferably carried out by the pump 26. The pump 26 is therefore configured to move (i.e. pump) liquid at least from the liquid source into the filtering unit 70 in order to be filtered by the first cavity 71 and to dispense the so filtered liquid via the first outlet 76 into the discharge line 23 and finally out of the discharge outlet 24. Additionally, the liquid source may be arranged such that liquid is supplied or moved from the liquid source into the filtering unit 70 for filtering and, subsequently, into the discharge line 23 by gravity, so that the gravity supports the pumping by the pump 26 from the liquid source into the discharge line 23. The pump 26 can thus be downsized, i.e. designed in a simpler manner. For example, a valve may be provided, which is configured to selectively allow or not allow a flow of liquid from the liquid source into filtering unit 70 and/or the discharge line 23.

The liquid source, in particular the liquid tank 100, may be adapted to cool the liquid contained therein. For example, the liquid source or the beverage system 1 may comprise a cooling unit (not shown) to cool or chill the liquid within the liquid source. The liquid may thus be cooled to comprise a temperature in the range from 0° C. to 5° C.

The beverage system 1 may comprise a UV lamp 40 arranged for irradiating UV light at a position along the discharge line 23 to sanitize the liquid. Sanitizing liquid with UV light may be also called ultraviolet germicidal irradiation (UVGI). More specifically, the irradiating UV light (short-wavelength ultraviolet, UV-C) kills or inactivates the germs by destroying structures of the germs, such as nucleid acis, leaving the germs unable to produce a disease. In particular, the UV light kills or inactivates germs such as microorganisms by destroying biomolecules such as nucleid acids and disrupting their DNA, leaving them unable to perform vital cellular functions. Consequently, germs in the liquid can be eliminated or at least significantly reduced, thereby, in addition to the filtering unit 70, sanitizing and purifying the liquid. The wavelengths of the irradiated UV light may be short-wavelength UV (UVC; “germicidal UV”) and/or may be in the range from about 200 nm to 300 nm. These wavelengths are strongly absorbed by the germs/nucleic acids, wherein the absorbed energy results in defects of the germs, including, for example, pyrimidine dimers. These dimers can prevent replication or can prevent the expression of necessary proteins, resulting in the death or inactivation of the organism of the germ. The UV lamp 40 may comprise a light source arranged for emitting (irradiating) the UV light. For example, the UV lamp 40 comprises a Mercury based lamp, ultraviolet light-emitting diodes, and/or a pulsed-xenon lamp.

In general, the UV lamp 40 may be arranged at any position suitable for sanitizing the liquid, which is to be discharged via the discharge outlet 24, by the irradiated UV light. For example, the UV lamp 40 may be arranged to irradiate UV light into the first section 28 and/or the second section 27, 30 of the discharge line 23, in particular into one or more of the inlet line 27, delivery line 30, and first section 28 (such as into the straightly and/or arcuately extending part of the first section 28). The UV lamp 40 may be arranged to irradiate the UV light at the discharge outlet 24. The UV lamp 40 may be a single UV lamp or may comprise a plurality of UV lamps, wherein each of these UV lamps is arranged to irradiate UV light into a respective one of the lines 27, 30, 28. The beverage system 1 may further comprise an in-line carbonation device 50. The in-line carbonation device 50 is adapted for entering carbon dioxide (CO₂) into the circulating liquid. For example, the carbon dioxide may enter into the circulating liquid in the discharge line 23. For example, an orifice 51 may be arranged in the first section 28 of the discharge line 23. As such, the orifice 51 may connect a part, such as a straight part, of the discharge line 23 or first section 28 with another part, such as an arcuate part, of the discharge line 23 or first section 28; in other words, the orifice 51 may be arranged between those parts of the discharge line 23. As such, the carbon dioxide from the in-line carbonation device 50 may enter into this orifice 51. The orifice 51 may extend straight and/or may be designed as a chamber, such as a mixing chamber. The chamber may facilitate that the carbon dioxide effectively enters into the circulating liquid. A carbon dioxide line 52 may be arranged to connect the in-line carbonation device 50 with the circulating liquid, for example with the discharge line 23 so that the carbon dioxide can enter into the circulating liquid. In the carbon dioxide line 52, a valve 53 (e.g. an on/off valve) may be arranged to selectively enter carbon dioxide into the circulating liquid.

The beverage system 1 may further comprise a beverage additive section 60 for dispensing additives, e.g. via the discharge outlet 24. With respect to a flow direction from the liquid inlet 21 via the discharge line 23 and to the discharge outlet 24, the beverage additive section 60 may add the additives at a position upstream or downstream of the discharge outlet 24, or at the discharge outlet 24. The beverage additive section 60 may be arranged to dispense only additives and/or to add the additives to liquid so that the additives provided in the liquid are subsequently dispensed by the discharge outlet 24 and added to or mixed with the liquid discharged from the discharge line 23. The beverage additive section 60 may add the additives to (purified) liquid, which is already sanitized.

The beverage system 1 comprises a further, i.e. secondary, discharge line 61. The filtering unit 70 is, with the second outlet 82, functionally connectable or connected to the (secondary) discharge line 61, e.g. via a liquid inlet 61a of the discharge line 61. Thus, liquid, filtered by the second filtering technology of the filtering unit 70, is delivered or dispensed into the discharge line 61, such as by operating a pump 62. The pump 62 (e.g. an infusion pump) is adapted to pump liquid from the liquid source (e.g. the liquid tank 100) through the filtering unit 70, thereby filtering the liquid with the second filtering technology; subsequently, the filtered liquid is dispensed by the second outlet 85 into the secondary discharge line 61, e.g. via the liquid inlet 61a.

As can be seen in FIG. 9, the beverage system 1 may comprise a heating unit (such as boiler) 63 arranged for heating the liquid flowing through the secondary discharge line 61. As such, the liquid flowing through the secondary discharge line 61 can be heated up for consumption (such as for a hot beverage to be dispensed) and/or for sanitization. The heating unit 63 may be adapted to heat the liquid so that the liquid becomes a defined temperature, such as in the range from 80° C. to 100° C. and/or sufficient for sanitization. The secondary discharge line 61 may be connectable to the beverage additive section 60. As such, the liquid, for example previously heated by the heating unit 63, may be delivered via the discharge line 61 into the beverage additive section 60 so that additives can be heated to this liquid, which may be heated up. Hence, the additives added to the (heated liquid) may further develop, for example with respect to the function of the additive and/or the taste of the additive, e.g. by effecting, with the (heated) liquid, a chemical reaction such as extraction or infusion. The heating unit 63 may be arranged downstream of the pump 62 and upstream of a section, where the additives are added, with respect to the flow direction of the pump 62.

The secondary discharge line 61 may be selectively connectable to the discharge line 23. More specifically, and as shown in FIG. 9, the secondary discharge line 61 may selectively connect, in a first position of a valve 69, to the discharge line 23, in particular to the delivery line 30. As such, liquid is pumped, for example by the pump 62, into the secondary discharge line 61, subsequently heated by the heating unit 63 and finally delivered into the discharge line 23, such as into the delivery line 30. The heated liquid flows via the discharge line 23 towards and then through the discharge outlet 24. Since the liquid is heated, the flow of liquid can facilitate the cleaning of the discharge line 23, such as the releasing of impurities (biofilm, germs, etc.) from the discharge line 23. In a second position of the valve 69, which is exemplarily shown in FIG. 9, the secondary discharge line 61 may be disconnected from the discharge line 23 in order to be used or connected with the beverage additive section 60. As such, the liquid, in particular previously heated by the heating unit 63, is delivered into the beverage additive section 60 so that additives, added to the (heated) liquid, may further develop in the heated liquid, for example with respect to the function of the additive and/or the taste of the additive, e.g. by effecting a chemical reaction such as extraction or infusion with the heated liquid.

The beverage additive section 60 may be adapted to inject air into the additive and/or the liquid of the secondary discharge line 62, to which the additive is added. For example, the beverage additive section 61 comprises an air pump 64 for said injection of air. The beverage additive section 60 may be operable in a first mode and a second mode, wherein in the first mode air injection is carried out/activated, wherein in the second mode air injection is not carried out/deactivated. For moving the beverage additive section 60 between these two modes, the beverage additive section 60 may comprise a valve 65 such as a (two-) way valve. The beverage additive section 60 may comprise an exhaust port 67, which is adapted for exhausting air out of the beverage additive section 60 and/or out of a container (such as a capsule) that contains the additive. The exhaust port 67 may be selectively moved between an open (exhaust) position and a closed position, e.g. by way of a (two-) way valve 68. The beverage system 1 may be adapted to pierce with an outlet needle into the container (e.g. capsule) so that at least part of the beverage prepared from the liquid and the additive is dispensed via the outlet needle. For cleaning the outlet needle, (heated) liquid from the discharge line 61 may be directed by the air, which is injected with the air pump 64 into the container, towards the outlet needle. At the same time, the exhaust port 67 is arranged to exhaust air from the container, while cleaning the outlet needle with air from the air pump 64 and with the liquid is carried out. Hence, the exhaust port 67 ensures that the pressure in the container does not rise during this cleaning.

The additive may be in the form of a liquid or in the form of a liquid, which comprises solid (additive) particles. The additive may be provided in a dedicated container (a cartridge, a capsule, etc.) that may be detachably connected to and/or may be adapted to be removed from the beverage additive section 60. Dependent on the consumer's desire, one and the same device 1 can thus be equipped with different kinds of additives. For example, the beverage system 1 may be adapted to choose among a plurality of additives. The additives may be added to provide infused liquid. For example, the additives comprise at least one of the group consisting of: flavours, aromas (for example orange, peach, lemon, etc.), minerals, a mineral liquid concentrate, a functional concentrate (such as an additive comprising a vitamin, caffeine or another coffee extract), an edible flavouring concentrate, a tea and/or coffee extract, a fruit juice, a minerals mother solution or combinations thereof. A “functional concentrate” is to be understood as having an effect on the consumer, such as a product that is probiotic, prophylactic, etc. The beverage additive section 60 is preferably adapted to dispense the additives to the liquid from the primary discharge line 23 and/or the secondary discharge line 61 such that the additives designate an amount up to 5%, preferably 0.05% to 1%, preferably 0.1% to 0.5% by volume, of the resulting liquid material in the final (beverage) product. In general, the final product may be (pure) liquid, soda, lemonade, a soup, etc.

The beverage system 1 may further comprise one or more flushing lines. For example, the beverage system 1 comprises at least a flushing line 90. The flushing line 90 has a respective flushing outlet 91. Further, the beverage system 1 may be configured to operate in a discharging mode and in a flushing mode, i.e. the beverage system 1 may be selectively switchable into the discharging mode or the flushing mode. In the discharging mode, the beverage system 1 is arranged for dispensing a beverage, which means that the pump 26 is arranged to circulate liquid out of the first outlet 76, along the discharge line 23 and towards and out of the discharge outlet 24, preferably into the container 25, and/or the pump 62 is arranged to circulate liquid out of the second outlet 82, along the discharge line 61 and towards and out of the discharge outlet 24, preferably into the container 25. When the beverage system 1 switches into the flushing mode, the discharging via the discharge outlet 24 stops and the at least one flushing line 90 comes into use.

In the flushing mode, at least part of the liquid in the discharge line 23 (at least 50 ml), such as residual liquid, then preferably flows by gravity from the discharge line 23 into the flushing line 90 and subsequently out of the flushing outlet 91. This provides a very cheap solution for flushing and, thus, cleaning the discharge line 23, since the pump 26 or any other means, which requires external (electrical) energy, is not necessarily required to operate for the flushing. In the flushing mode, the pump 26 may thus be deactivated. However, in the flushing mode, the pump 26 may be also activated in order to support the flushing, that is, in the flushing mode, the pump 26 may be activated and arranged to draw at least part of the liquid from the discharge line 23 into the flushing line 90 and subsequently out of the flushing outlet 91. The pump 26 thus draws liquid along a direction of the discharge line 23, which is opposite to the direction, along which the liquid circulates along the discharge line 23 to be subsequently discharged via the discharge outlet 24. Thus, a very effective cleaning of the beverage system 1, in particular of the discharge line 23, is achieved.

In order to provide a particularly good flushing by the gravity effect, at least part of the discharge line 23, such as the first section 28 of the discharge line 23 and/or the section 231, is, compared to the flushing line 90, arranged on a higher level with respect to the vertical. The flushing line 90 may extend substantially in the horizontal, or (slightly) oblique to the horizontal (such as at an angle in the range from 0.5-5°), whereas part of the discharge line 23, such as the first section 28, does not extend in the horizontal. For example, part of the first section 28 may extend only in the vertical. Thus, the residual liquid in the discharge line 23 can effectively flow by gravity into the flushing line 90, since almost all of the potential energy of said residual liquid in the discharge line 23 can be transformed into kinetic energy for the flow of said residual liquid in the flushing line 90.

Switching between the discharging mode and the flushing mode is preferably done automatically, for example by means of a (electronic) control unit (not shown). Additionally or alternatively, switching between the discharging mode and the flushing mode may be done manually, such as by means of a dedicated user interface (button, touchscreen, etc.). Based on certain parameters, an automatic switching into the flushing mode or the discharging mode may thus be carried out. Hence, a sufficient flushing frequency can be easily ensured. For example, based on a status of the beverage system 1, the beverage system 1 may switch between the discharging mode and the flushing mode. The status of the beverage system 1 may be detected or sensed by a dedicated sensor, or the status may be derived from parameters of the beverage system 1. As such, when the status fulfills a defined criterion, such as exceeding or falling below a defined threshold value, the beverage system 1, such as the control unit, may decide to (automatically) switch into the flushing mode or the discharging mode.

For example, the status may be of the filtering unit 70 and/or the liquid tank 100, such as the presence of the filtering unit 70 and/or the liquid tank 100. The presence and non-presence may be sensed by a dedicated presence sensor. Thus, when a non-presence is detected (i.e. when the filtering unit 70 and/or the liquid tank 100 is removed from the beverage system 1), the beverage system may automatically switch into the flushing mode. Correspondingly, when a presence of the filtering unit 70 and/or the liquid tank 100 is detected, the beverage system 1 may automatically switch out of the flushing mode, such as into the discharging mode. The detection of the presence may be implemented such that the time of the presence of the filtering unit 70 and/or the liquid tank 100 is detected, so that based on this time, e.g. when a pre-set time has lapsed, switching into the flushing mode is carried out. The beverage system 1 may also include a reminder function so that based on said time of the presence of the filtering unit 70 and/or the liquid tank 100, a reminder, such as in the form of a visual and/or acoustic signal, may be generated in order to remind the user of the beverage system 1 that the liquid (supply) stays for a (too) long period of time.

Additionally or alternatively, also other statuses of or with respect to the filtering unit 70 and/or the liquid tank 100 may be used for switching between the discharging mode and the flushing mode, such as the functional connection of first outlet 76 with the discharge line 23 and/or of the second outlet 82 with the discharge line 61, the residence time of liquid at a specific level in the liquid tank 100, and/or the temperature of the liquid to be filtered. The functional connection may be detected by a dedicated sensor, for example a sensor detecting whether the first outlet 76 properly mates with the discharge line 23 (e.g. inlet 21) and/or whether the second outlet 82 properly mates with the discharge line 61 (e.g. inlet 61a). The level of the liquid in the liquid tank 100 and/or the temperature of the liquid may be respectively sensed by a dedicated sensor, i.e. a level sensor and a thermometer, respectively. The residence time at the specific level and/or the temperature of the liquid in the liquid tank 100 may be an indicator that for a (too) long time no beverage has been dispensed and that, thus, a cleaning of the beverage system 1 by switching into the flushing mode is required. The status of the beverage system 1 may be in general the lapsed time in which no liquid is discharged via the discharge outlet 24. Thus, when this lapsed (continuous) time exceeds a predefined time, the beverage system 1 may automatically switch into the flushing mode.

The flushing line 90 may be arranged to selectively connect to the discharge line 23 (flushing mode) or disconnect from the discharge line 23 (discharging mode) in order to switch between the discharging mode and the flushing mode. For example, the beverage system 1 may comprise one or more valves so that based on controlling these valves (by the control unit) the beverage system 1 switches between the discharging mode and the flushing mode. In the embodiment shown in FIG. 9, the beverage system 1 comprises a valve 93 for switching between the discharging mode and the flushing mode. More specifically, the valve 93 is moveable between a first position and a second position, wherein in the first position the beverage system 1 is in the discharging mode (see FIG. 9), and wherein in the second position the beverage system 1 is in the flushing mode. As shown in FIG. 9, the valve 93 may, in the first position (discharging mode), connect the first section 28 of the discharge line 23 with the second section 27, 30 of the discharge line 23, in particular with the delivery line 30. In the second position of the valve 93, the valve 93 may connect the first section 28 with the flushing line 90, so that at least part of the liquid of the discharge line 23 can flow from the first section 28 via the valve 93 into the flushing line 90 to be discharged via the flushing outlet 91. Consequently, the first section 28 is not connected to (i.e. separated from) the second section 27, 30, when the valve 93 is in the second position.

In order to collect the liquid, which flows out of the flushing outlet 91, the beverage system 1 may comprise a collecting container 94, such as a drip tray. The collecting container 94 is thus arranged to collect the liquid, which flows via the flushing outlet 91 out of the one or more flushing lines 90. The collecting container 94 may be also arranged to collect liquid, such as residual liquid, which flows out of the discharge outlet 94. As such, the collecting container 94 may be arranged opposite to the discharge outlet 24 or may be arranged to face the discharge outlet 24. If the collecting container 94 is designed as a support for the container 25, or if the collecting container 94 is arranged below the support for the container 25, the container 25 is, when used for collecting the beverage dispensed from the discharge outlet 24, preferably arranged between the discharge outlet 24 and the collecting container 94. The collecting container 94 may be removably arranged with respect to the beverage system 1, so that a user can easily remove the container 94 and, thus, dispose of the liquid collected by the container 94.

The beverage system 1 may further comprises a further (second) flushing line 95. The description with respect to the first flushing line 90 applies, unless specified differently, to the second flushing line 95 analogously. Accordingly, the second flushing line 95 comprises a respective (second) flushing outlet 96. Thus, in the flushing mode, at least part of the liquid in the discharge line 23 flows by gravity, preferably at least in part supported by the pump 26, into the flushing lines 90, 95 and out of their respective flushing outlets 91, 96. In the flushing mode, the second section 27, 30 of the discharge line 23 may be connected to the second flushing line 95. Residual liquid in the first section 28 of the discharge line 23 thus flows into the first flushing line 90, and residual liquid in the second section 27, 30 of the discharge line 23 flows into the second flushing line 95. In order to provide a particularly good flushing by gravity, the second section 27, 30 of the discharge line 23 may at least in part extend vertically.

The flushing lines 90, 95 are not limited to a specific arrangement with respect to one another. Compared to the second flushing line 95, the first flushing line 90 may be arranged at a higher level with respect to the vertical. Thus, the first flushing line 90 may be arranged for removing residual liquid from the part of the discharge line 23, which extends on a first (higher) level, such as from the first section 28, and the second flushing line 95 may be arranged for removing residual liquid from the part of the discharge line 23, which extends on a second (with respect to the first level lower) level, such as the section 27, 30. The flushing lines 90, 95 may at least in part extend horizontally and/or parallel to one another. The collecting container 94 may be arranged to collect the liquid, which flows via the flushing outlet 96 out of the flushing line 95. The flushing outlet 96 may be arranged such that liquid flowing out of the flushing outlet 96 flows into the container 94 from a lateral side of the container 94. The flushing outlet 91 may be arranged such that liquid flowing out of the flushing outlet 91 flows into the container 94 along a direction from above of the container 94, such as along a vertical direction.

For switching the beverage system 1 between the discharging mode and the flushing mode based on controlling valves (by the control unit), the beverage system 1 may comprises the (first) valve 93 and a further (second) valve 97. This valve 97 is designed and arranged analogously to the valve 93. That is, the valve 97 may be moveable between a first position and a second position, wherein, in the first position, the beverage system 1 is in the discharging mode, and wherein, in the second position, the beverage system 1 is in the flushing mode. As shown in FIG. 9, the valve 97 may, in the first position (discharging mode), not connect the second section 27, 30 of the discharge line 23 to (i.e. disconnected from) the second flushing line 95. In the second position of the valve 97, the valve 97 may connect the second section 27, 30 with the second flushing line 95, so that residual liquid in the second section 27, 30, i.e. in both the inlet line 27 and the delivery line 30, can flow by gravity via the valve 97 into the second flushing line 95 to be discharged via the flushing outlet 96. A particularly good flushing of the discharge line 23 is thus achieved, namely a flushing of both the first section 28 (by the first flushing line 90) and the second section 27, 30 (by the second flushing line 95). Additionally or alternatively, in the second position of the valve 97, the valve 97 may connect the first outlet 76 and/or the inlet 21 with the second flushing line 95, so that residual liquid in the first cavity 71 and/or the first outlet 76 and/or the inlet 21 can flow by gravity via the valve 97 into the second flushing line 95 to be discharged via the flushing outlet 96.

Preferably, in the flushing mode, at least part of the liquid in the discharge line 61 flows by gravity, preferably at least in part supported by the pump 62, into the flushing line 95 and out of the flushing outlet 96. The beverage system 1 may comprises a (third) valve 98. This valve 98 is designed and arranged analogously to the valve 93 and/or valve 97. That is, the valve 98 may be moveable between a first position and a second position, wherein, in the first position, the beverage system 1 is in the discharging mode, and wherein, in the second position, the beverage system 1 is in the flushing mode. As shown in FIG. 9, the valve 98 may, in the first position (discharging mode), not connect the discharge line 61 to (i.e. disconnect from) the second flushing line 95. In the second position of the valve 98, the valve 98 may connect the discharge line 61 with the second flushing line 95, so that residual liquid in the discharge line 61 can flow by gravity via the valve 98 into the second flushing line 95 to be discharged via the flushing outlet 96. Additionally or alternatively, in the second position of the valve 98, the valve 98 may connect the second outlet 82 and/or the inlet 61a with the second flushing line 95, so that residual liquid in the second cavity 77 and/or the second outlet 82 and/or the inlet 61a can flow by gravity via the valve 98 into the second flushing line 95 to be discharged via the flushing outlet 96.

The beverage system 1 may operable in at least a first filtration mode, in which (only) the first filtering technology filters the liquid for the beverage to be prepared (such as a cold beverage, e.g. with the original mineral content), a second filtration mode, in which (only) the second filtering technology filters the liquid for the beverage to be prepared (such as a hot beverage, e.g. with a low mineral content, i.e. a reduced liquid hardness, in order to avoid scale and technical problems) and, preferably, in a third filtration mode, in which both the first filtering technology and the second filtering technology filter the liquid for the beverage to be prepared. The beverage system 1 in particular facilitates that, (only) based on operating the pumps 26, 62, the beverage system 1 may switch in one of the at least two and preferably three modes.

It should be clear to a skilled person that the embodiments shown in the figures are only preferred embodiments, but that, however, also other designs of a filtering unit 70, system, and beverage system 1 can be used. For example, the filtering unit 70 may also comprise more than two (e.g. three or four) cavities, each cavity with a respective filtering technology that is different from the respective other filtering technologies, and all of the cavities being integrated in a same unit. In general, a “line” is to be understood in a broad manner, i.e. any structure adapted for conveying, guiding and/or moving a liquid or fluid. For example, a “line” may be a tube, a pipe, a channel, or a conduit.

1. A filtering unit, comprising:
a first cavity with a first filtering technology for filtering a liquid, and with a first outlet for dispensing the liquid filtered by the first filtering technology,
a second cavity with a second filtering technology, which is different from the first filtering technology, for filtering a liquid, and with a second outlet for dispensing the liquid filtered by the second filtering technology, and
wherein the first cavity and the second cavity are integrated in a same unit.

2. The filtering unit according to claim 1, wherein the first filtering technology is adapted to filter,
impurities, such as pathogens and/or organic pollutants and contaminants, and
substances affecting the taste and/or odor of the liquid, such as chlorine.

3. The filtering unit according to claim 1, wherein the first cavity comprises an activated carbon filtering means for providing the first filtering technology.

4. The filtering unit according to claim 1, wherein the second filtering technology is adapted to filter,
impurities, such as pathogens and/or organic pollutants and contaminants, and
substances affecting the taste and/or odor of the liquid,
wherein the second filtering technology is adapted to remove and/or exchange heavy metals in the liquid.

5. The filtering unit according to claim 1, wherein the second filtering technology is adapted to remove and/or exchange minerals, in order to reduce the liquid hardness.

6. The filtering unit according to claim 1, wherein the second cavity comprises an ion exchange resin and an activated carbon filtering means for providing the second filtering technology.

7. The filtering unit according to claim 1, wherein the first cavity comprises a first filtering structure extending along a first length and for providing the first filtering technology, and wherein the second cavity comprises a second filtering structure extending along a second length and for providing the second filtering technology, wherein the first length is greater than the second length, or wherein the second length is greater than the first length.

8. The filtering unit according to claim 1, wherein the cavities are integrated in the same unit is such a way that the filtering unit can be connected to and/or at least partially arranged in a same liquid source so that liquid from the same liquid source can be fed to the cavities in order to be filtered.

9. A system, comprising a liquid tank and a filtering unit comprising:
a first cavity with a first filtering technology for filtering a liquid, and with a first outlet for dispensing the liquid filtered by the first filtering technology,
a second cavity with a second filtering technology, which is different from the first filtering technology, for filtering a liquid, and with a second outlet for dispensing the liquid filtered by the second filtering technology, and
wherein the first cavity and the second cavity are integrated in a same unit.

10. The system according to claim 9, wherein the filtering unit is arranged on the liquid tank and/or at least partially or completely inside of the liquid tank.

11. The system according to claim 9, wherein the liquid tank is adapted to arrange the filtering unit in a specific position and/or orientation, so that only in this position and/or orientation the filtering unit is functionally connected to the liquid tank for filtering liquid contained in the liquid tank.

12. The system according to claim 11, wherein the liquid tank comprises one or more sections adapted, in particular shaped and/or sized, to cooperate with the first cavity and/or second cavity in such a way that the filtering unit is arranged in the specific position and/or orientation.

13-14. (canceled)

15. A method of filtration, the method comprising the following steps:
filtering, with a first filtering technology arranged in a first cavity, a first amount of liquid,
dispensing, with a first outlet provided by the first cavity, the first amount of liquid filtered by the first filtering technology,
filtering, with a second filtering technology that is arranged in a second cavity and different from the first filtering technology, a second amount of liquid, and
dispensing, with a second outlet provided by the second cavity, the second liquid filtered by the second filtering technology,
wherein the first cavity and the second cavity are integrated in a same unit, and wherein the first amount of liquid and the second amount of liquid are preferably from a same liquid source.
